(19) United States
(12) Patent Application Publication
(10) Pub. No.: US 2012/0293637 A1
(43) Pub. Date: Nov. 22, 2012

(54) Bufferless 3D On Screen Display

(75) Inventor: William J. Ivanich, Parker, CO (US)

(73) Assignee: EchoStar Technologies L.L.C., Englewood, CO (US)

(21) Appl. No.: 13/112,872

(22) Filed: May 20, 2011

(51) Int. Cl. H04N 13/04

(52) U.S. Cl. 348/51; 348/E13.026

(57) ABSTRACT

A system, method and computer program product provide 3D on screen display content derived from 2D image content utilizing the on screen display image buffer, as opposed to an on screen display 3D buffer, of a content receiver. The on screen display image buffer separates image data for one image formatted as a 2D image into data for a first image and data for a second image. Utilizing the data for the first and second image, the on screen display image buffer formats the first and second image data for an offset display on a content display device so that a user perceives the first and the second image as a 3D image forming a portion of the on screen display. The first and second image for each of the original images may have differing offsets relative to one another thereby providing the perception of differing levels of depth for each of the 3D images.

### FIELD OF THE INVENTION

This disclosure relates generally to providing 3D content utilizing image buffers of a content display device, and more specifically to utilizing the content display device image buffer to convert 2D image data to 3D image data.

### SUMMARY

The present disclosure discloses systems and methods for providing 3D on screen display content utilizing an on screen display image buffer of a content receiver to convert 2D image data to 3D image data. This is in contrast to utilizing an on screen display 3D buffer for providing 3D on screen display content. It will be understood that the on screen display image buffer is generally independent from a video image buffer and a video 3D buffer.

According to one implementation, a method for providing on screen display content in a 3D format involves utilizing a content receiver. The content receiver receives image data corresponding to one of a plurality of images to be transmitted to a content display device for display as an on screen display, and the on screen display is separate from video content displayed by the content display device. The method continues as the content receiver provides the image data to an on screen display image buffer residing therein, e.g., in a processing unit. The on screen display image buffer separates the image data into data for a first image and data for a second image and formats the data for the first image and the data for the second image for an offset display on the content display device. The content receiver transmits the formatted data for the first and the second image to the content display device, and the formatted first and second images displayed on the content display device are configured to be perceived as a 3D image forming a portion of the on screen display.

In another implementation, a system provides on screen display content in a 3D format utilizing a content receiver. The system includes an on screen display image buffer. A processing unit controls the on screen display image buffer and is operative to retrieve image data corresponding to one of a plurality of images to be transmitted to a content display device for display as an on screen display that is separate from video content displayed by the content display device. The content receiver includes a memory unit having memory accessible by the on screen display image buffer. The screen display image buffer separates the image data into data for a first image and data for a second image, and formats the data for the first image and the data for the second image for an offset display on the content display device. The content receiver also includes a communications unit for transmitting the formatted data for the first and the second image to the content display device. The formatted first and second images transmitted to the content display device form a three-dimensional perceptual image as a portion of the on screen display.

In another implementation, a computer program product includes a first set of instructions, stored in at least one non-transitory machine readable medium, executable by at least one processing unit that separates image data into data for a first image and data for a second image. The image data corresponds to data for one of a plurality of images to be transmitted to a content display device for display as an on screen display that is separate from video content displayed by the content display device. A second set of instructions, stored in the at least one non-transitory machine readable medium, executable by the at least one processing unit formats the data for the first image and the data for the second image for an offset display on the content display device. The image data is formatted such that the formatted first and second images transmitted to the content display device form a three-dimensional perceptual image as a portion of the on screen display.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for providing 3D on screen display content utilizing the on screen display image buffer, as opposed to an on screen display 3D buffer, of a content receiver.

FIG. 2 is a flow chart illustrating a method for providing 3D on screen display content utilizing the on screen display image buffer of the content receiver. This method may be performed by the system of FIG. 1.

FIGS. 3A-3C are diagrams illustrating a system for providing 3D on screen display content utilizing the on screen display image buffer of a content receiver. The system of FIGS. 3A-3C may be the system of FIG. 1.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

Electronic devices such as content receivers (like set top boxes) generally receive content from a content stream and decode and transmit the video, audio and data content from the content stream to a content display device (such as a television). Some content display devices are capable of projecting the content to a display screen in a way such that the images displayed form a three-dimensional (“3D”) perceptual image perceived by the user as an image with depth. The perception of a 3D image projecting from the display screen is due to the content receiver transmitting content as a first image and a second image, such as a left image and a right image or as a top image and a bottom image, each of which are generally offset (such as partially separated and arranged adjacent, side-by-side, left and right, and top and bottom) from one another, which (generally with the aid of 3D glasses) results in the human eye perceiving the two images as one image projecting out from the display screen giving the user the perception of a 3D image. For purposes of discussion, only the first image and the second image are described in connection with 3D imaging, but it will be understood that a left or top image or a right or bottom image can be thought of as being interchangeable with the term first image and that the other of the right or left or top or bottom image can be thought of as interchangeable with the term second image. The 3D image displayed as the first image and the second image may be generated from a two-dimensional image (“2D”) utilizing hardware resident in the content receiver box or the content receiver may receive content formatted into 3D, i.e., split into left and right images. For example, a video player (e.g., a DVD player) or a content provider (e.g., satellite cable company) may transmit a content stream to the content display device in a 3D format.

However, when content is converted from 2D to 3D utilizing the content receiver, hardware including memory contained therein is required to be used to a large extent. More specifically, a large amount of random access memory (“RAM”) is utilized for a 3D buffer to resize and create first and second images. This 3D buffer for image conversion from 2D to 3D is a buffer that is in addition to an image buffer that is operable to render images for transmission to a display screen.

Moreover, content receivers utilize multiple different buffers for rendering video content and for rendering on screen display content (e.g., television programming guides, text, user-selectable commands, icons or buttons that are generally arranged discretely or separate from video content). Because content receivers have limited amounts of RAM, multiple buffers utilizing the RAM at the same time can slow the operation of the content receiver. As a result, an on screen display 3D buffer may be pre-set so as to be inoperable while a 3D video buffer renders 3D video content. That is, the content receiver may only allow one of the on screen display 3D buffer or the video 3D buffer to be operable at one time.

In addition, switching RAM operations from video 3D buffering to on screen display 3D buffering means that displaying 3D video content on a content display device would be interrupted in order for the on screen display 3D content to be viewed. This interruption in video 3D content would most likely be undesirable for a user enjoying the 3D video content. As a result, the video 3D buffer would generally be given priority for its operation compared to the on screen display 3D buffer.

The present disclosure discloses systems and methods for utilizing a content receiver at an application level to convert on screen display content from 2D to 3D without a 3D image buffer. The content receiver receives a stream of 2D on screen display content to be converted to 3D first and second images, and provides the stream to an image buffer (as opposed to a 3D buffer). The image buffer of the content receiver is programmed to execute instructions so that during rendering of the image data utilizing the image buffer, the image data for a single image is divided into two images. This enables the image buffer to resize and format a first image and a second image for display as a left and right or a top and bottom image for example. The two resized and formatted images that originate from the single image are transmitted to the content display device by the content receiver. By utilizing an image buffer to split a single image into a first image and a second image, the image data associated with the single image remains intact but is provided in a proportioned, divided manner. Thus, image data is not lost as the image buffer divides the single image into two.

As the on screen display image buffer operates to divide a singe image into two and formats and resizes the images for 3D viewing, less RAM is utilized compared that required by utilizing both an image buffer and an on screen display 3D buffer for the on screen display. As a result, enough RAM is available to allow both the video 3D buffer and the on screen display image buffer to operate simultaneously without slowing the operation of the content receiver, and 3D video and 3D on screen display content may be viewed simultaneously on a display screen.

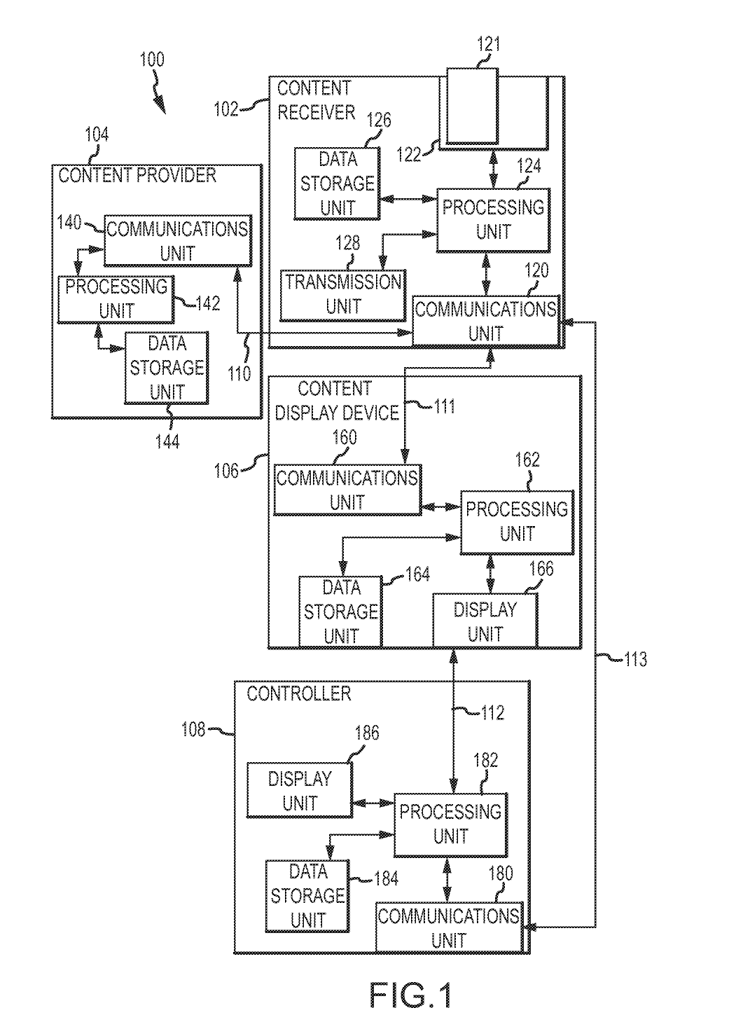

FIG. 1 is a block diagram illustrating a system 100 for providing 3D on screen display content derived from 2D formatted images utilizing the on screen display image buffer, as opposed to an on screen display 3D buffer, of a content receiver. The system 100 includes a content receiver 102 (such as a set top box) for receiving and transmitting content (such as television programming and on screen display content), a content provider 104 for transmitting the content (such as a satellite or cable programming service provider), a content display device 106 for receiving and displaying the content (such as a television), and a controller 108 (such as a remote control) for transmitting data such as control signals to the content receiver 102.

The content receiver 102 is a device for receiving content from the content provider 104 and other external sources, for processing or decoding the content and for transmitting the content to the content display device 106. The content receiver 102 is, for example, a set top box, a television receiver, a digital video recorder, a computing device, a gaming device, or a television, which is generally located at a user's location (such as a user's residence or business). The content receiver 102 is operable to receive 2D and 3D content from the content provider 104 (and/or another external source) by way of the transmission link 110. Such content is received by the communications unit 120 of the content receiver 102. The content receiver 102 is also operable to receive 2D or 3D content from an external source 121 by way of data port 122 (e.g., USB port). For example, the data port 122 may be a USB port connectable to a flash drive, a mobile computing device such as a phone (e.g., a smart phone and/or a camera phone), a digital tablet, and the like. The data from the content provider 104 and the external source 121 is provided to the processing unit 124 for executing instructions stored in the data storage unit 126 and for providing content to the content display device 108 and/or audio speakers via the transmission unit 128. The transmission unit 128 is communicatively coupled to the content display device 106 by way of the processing unit 124, the communications unit 120 and the transmission link 111. The processing unit 124 also executes instructions stored in the data storage unit 126 for operating an on screen display image buffer, described below, a video image buffer, and a video 3D buffer.

The content provider 104 (such as a satellite programming company, a cable company, an Internet service provider, e.g., an online video service or Internet video provider, and the like) is generally remotely located from the content receiver 102. The content provider 104 utilizes a communications unit 140, a processing unit 142 and a data storage unit 144 to receive, manage and store content, which is transmitted as 2D or 3D content by the communications unit 140 to the communications unit 120 of the content receiver 102 via the transmission link 110. It will be appreciated that on screen display content transmitted by the content provider 104 in the content stream (e.g., stream of video, audio and metadata containing the on screen display content) is generally transmitted in 2D format, but may also be transmitted in 3D format. Although not shown, a video player (such as DVD player) may also be communicatively coupled to the content receiver 102 by way of the transmission link 110 and transmit content in 2D or 3D format.

The content display device 106 is generally arranged proximate to and is communicatively coupled to the content receiver 102 and displays 2D and 3D content. While content display device 106 and the content receiver 102 are depicted as separate components in FIG. 1, the content receiver 102 may be incorporated with the content display device 106. The content display device 106 is, for example, a 3D television, a 3D computer screen, a 3D video screen, or any other 3D display device for displaying 3D content or 3D images capable of forming a 3D perceptual image that may be perceived by the user as having depth. The content display device 106 includes a communications unit 160, which receives 2D and 3D content from the communications unit 120 of the content receiver 102 by way of the transmission link 111. The content display device 106 also includes a processing unit 162 for executing instructions stored in a data storage unit 164, and a display unit 166 for displaying the content received from the content receiver 102.

The controller 108 is generally provided in an area proximate the content receiver 102 and is communicatively coupled to the content display device 106 by way of the transmission link 112, and to the content receiver 102 by way of the transmission link 113. The controller 108 is, for example, a remote control, such as a universal remote control, a dedicated remote control, or a computing device programmed to send command signals to the content receiver 102. The controller 108 includes a communications unit 180 for sending and receiving information, a processing unit 182 for executing instructions stored in a data storage unit 184, and an optional display unit 186 for displaying or presenting information stored within the data storage unit 184 such as information related to a command sent to the content receiver 102.

Returning to the content receiver 102, the processing unit 124 executes instructions stored in the data storage unit 126 for the operation of the on screen display image buffer. The on screen display image buffer may be provided by an application layer, e.g., as a simple graphics image library (“SGIL”). The on screen display buffer builds the image to be transmitted to the display screen. This buffer formats the on screen display metadata content (such as television programming guides, text, user-selectable commands, icons or buttons for display on the content display device 106) from 2D images to 3D images.

According to certain implementations, the buffer operates on a per image basis, so that image data corresponding to one of a plurality of images to be transmitted to a content display device for display as an on screen display is received in a 2D format and separated into two images for 3D formatting and display. It will be understood that the image components associated with the on screen display content, such as icons, buttons, text (including words, numbers and symbols), menu or text boxes, lines (including framing lines or separator lines), and the like, may each be referred to as an image. It will also be understood that one image, e.g., a button image, may overlap another image, e.g. a word such as “select” to provide an image of a “select button,” for example. Each image may be converted from data for a 2D image to data for a 3D image utilizing the on screen display image buffer. The on screen display image buffer executes instructions that separates the image data for a single image into image data corresponding to two images. The data for the two image is formatted and resized into each of a first image and a second image. The display image buffer provides this data for the first and second images with an offset so that upon the processing unit 124 transmitting the image data to the content display device 106, a 3D perceptual image is formed and the user may perceive the image as a single image having depth.

According to certain implementations, utilizing the processing unit 124 of the content receiver 102, the on screen display image buffer executes a series of 3D conversion instructions, including obtaining data for the 2D image width, height and start location. The on screen display image buffer utilizes the obtained data to divide the single image using the pixels forming the image. For example, a number may be assigned to each successive pixel for an initial image. The number assigned may be in a successive manner, for example, the first pixel may be assigned number 1, the second pixel may be assigned number 2, the third pixel may be assigned number 3, and so on. The buffer then assigns the even numbered pixels to the first image and assigns the odd numbered pixels to the second image, or vice versa. The image data for the entire image may therefore be split in half based on the pixel number assigned, e.g., 50 percent of the initial image data is associated with the first image and 50 percent of the initial image data is associated with the second image. Because the two images including about half of the original image data are formatted and resized into a 3D format, a 3D perceptual image is formed and the user may perceive the image as a single image having depth.

In another example, the on screen display image buffer includes a first image buffer and a second image buffer and utilizes pointers to track pixel data in the first and second image buffers. Utilizing the image width, height and start location, a first or left pointer of the on screen display image buffer tracks pixel data provided to the first screen buffer. For a pixel assigned to the first buffer located on the left side of the screen, the pixel will be positioned on the left side of the screen but at half of the pixel start location. For example, a pixel from an initial image at start location of 200 is assigned a location of 100 (200*0.5) in the first image. For the second image, the second or right pointer tracks the pixels provided to the right screen buffer. For an adjacent pixel, e.g., pixel 201, located on the left side of the screen but provided to the right buffer, the position of the pixel will be at a location corresponding to half of the total combination of initial pixel position plus the pixel width of the screen. For example, for a pixel at an initial location of 201 and for a screen having a width of 752 pixels, the location of the pixel in the right buffer is (201+752)/2=476 (e.g., where a number ending in 0.5 (such as 476.5) is rounded down to the integer value). The calculations may be performed for each of the pixels within the image thereby separating the original image into two images for 3D formatting and displaying.

The on screen display image buffer may also divide the initial image into the two images based on additional data such as the pixel location, brightness, color and the like. For example, the on screen display image buffer may assign each pixel to the first or the second image based on the pixel coordinates, which may be in addition to or as an alternative to assigning a number to each pixel. The on screen display image buffer may also be configured to supplement the image data or individual pixels within the image, for example, to accentuate brightness or color.

Further, utilizing the processing unit 124 of the content receiver 102, the on screen display image buffer may be configured to control the spacing between the first and the second image in order to control the user's perception of the degree of depth of the 3D image on a per image basis. This is in contrast to the traditional image buffer that renders image data at preset locations and provides this image data to a driver for transmitting content to a display screen. The driver is generally not capable of independently adjusting the images, dividing the images or the offsetting the images.

The on screen display image buffer provided herein may execute instructions for offsetting the first and second images as well as adjusting the degree of offset of the images. By adjusting the degree of offset, the images may appear closer to or further away from the user's eye. Providing such a feature enables images on the on screen display to be perceived as 3D perceptual images having varying depths. Thus, for example, the background image of the onscreen display (such as the opaque or semi-transparent image that serves as a backdrop for other features depicted on the on screen display) may be assigned a certain offset, while the various images (such as active buttons or icons) may be assigned another offset that gives the perception that the various images are relatively closer to the user compared to the background. In addition, each of the various images may be assigned differing offsets so that certain images are given more focus (e.g., pop-out) to the user. For example, a prominently used image, such as a “select button” may be given a larger offset to give a larger degree of focus on the 3D display compared to other command buttons displayed. The degree of offset may be based on a degree of relevance the image is associated with, which may be predefined or dynamically set by the content receiver 102. For example, the image may become more or less relevant based on the frequency of use. In this case, where a user most frequently uses one or more images to execute selections while utilizing the on screen display, the content receiver 102 may dynamically set the frequently used images to be displayed more prominently, and thus may be perceived as being closer to the user, relative to other less commonly used images, which may be perceived as being further away or closer to the background image of the on screen display.

In another example, the arrangement of the images displayed on the on screen display may be dynamically adjusted by the content receiver 102 and or by the user utilizing the content receiver. For example, based on the frequency of use of a given image, the content receiver may place the image in a more prominent position as a 3D image, e.g., center the 3D image on the content display screen. In another example, the user may utilize a user-selectable options programmed in the content receiver 102 that enable the user to select an arrangement of the images displayed on the on screen display. In such implementations, the on screen display image buffer may be configured to dynamically offset the first and second images based on use, relevance or other information provided by the content receiver 102, the content provider 104 or the user, for example, by way of the controller 108.

In some implementations, the on screen display image data to be converted into the first and second images may include additional metadata related to the image and may provide instructions that may be utilized by the on screen display image buffer. For example, metadata may be provided in cases where it is known (e.g., by the content provider 104) that the image data will be converted into a 3D format. The metadata may provide instructions for separating, formatting and/or transmitting the image data to the content display device. In this example, the on screen display image buffer may execute instructions provided by both the metadata and by the memory unit 126. For example, the metadata provided with the image data may instruct the on screen display image buffer to provide one offset to some images and a different offset to other images and the processing unit 124 may execute instructions stored in the memory unit 126 for adjusting the depth of the images. In another example, metadata may include previously assigned pixel numbers, which may enable the on screen display image buffer to more quickly generate the first and the second images.

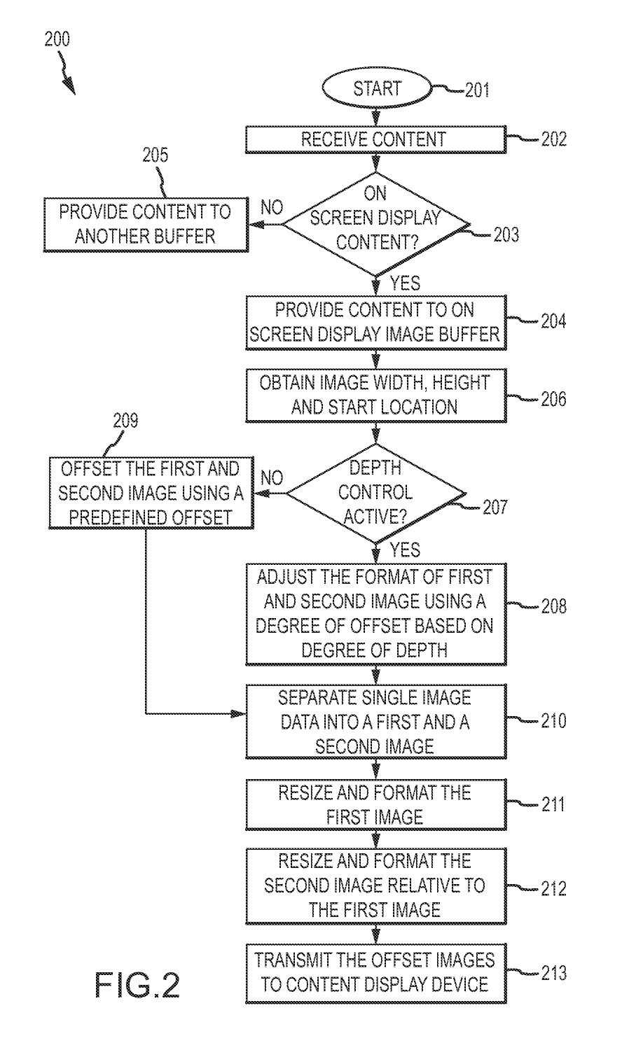

FIG. 2 illustrates a method 200 for providing 3D on screen display content utilizing the on screen display image buffer of the content receiver 102. The method 200 may be performed by the electronic device 100 of FIG. 1. The flow begins at block 201 and proceeds to block 202 where the content receiver 102 receives content, e.g., from the content provider 104. The flow then proceeds to block 203 where the processing unit 124 determines whether or not the received content is on screen display content. On screen display content (such as an on screen programming guide or selection menu) is generally composed of images received in a 2D format, i.e., a collection of single 2D images that make up the on screen display. If the content received is on screen display content, the flow proceeds to block 204 where the image content is provided to an on screen display image buffer of the processing unit 124. Where the content is not on screen display content, the flow proceeds to block 205 where the non-image content (e.g., video content) is provided to another buffer such as a video image buffer or a video 3D buffer.

At block 204, upon receipt of the image content at the on screen display image buffer, the flow proceeds to block 206 where data for the image width, height and start location are obtained by the processing unit 124. The flow then proceeds to block 207 where the image data for the image is separated into a first image and a second image. This image separation may be performed for each image making up the on screen display, but it will be understood that the on screen display image buffer may simultaneously separate multiple images at the same time on a per image basis. The flow then proceeds to block 208 where the first image from the separated images (i.e., the first image created from the original single image) is resized and formatted. This operation may involve formatting the first image for view by the user's left eye. The flow then proceeds to block 209 where the second image from the separated images is resized and formatted relative to the first image. This operation may involve formatting the second image for view by the user's right eye. In some implementations, the resizing and formatting may be performed in the same operation.

After the first and second images have been resized and formatted, the flow proceeds to block 210 where the processing unit 124 determines whether the depth control feature is active. The depth control feature enables each image of the on screen display to be depth-adjusted so that certain 3D perceptual images may appear closer to the user, while other 3D images may appear relatively recessed. If the depth control feature is active, the flow proceeds to block 211 where the offset of the first and second images are dynamically adjusted based on a perceived degree of depth to be associated with the 3D image. Otherwise, where the depth control feature is not active, the flow proceeds to block 212 where the first and second images are offset using a predefined offset. Upon offsetting the first and the second images, utilizing either blocks 211 or 212, the flow proceeds to block 213 where the processing unit 124 transmits the offset images to the content display device.

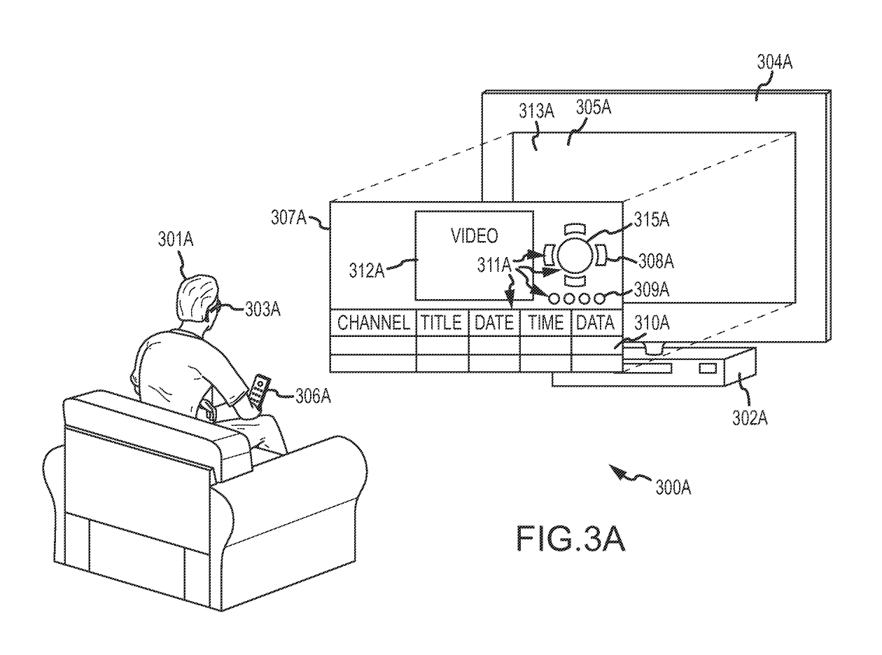

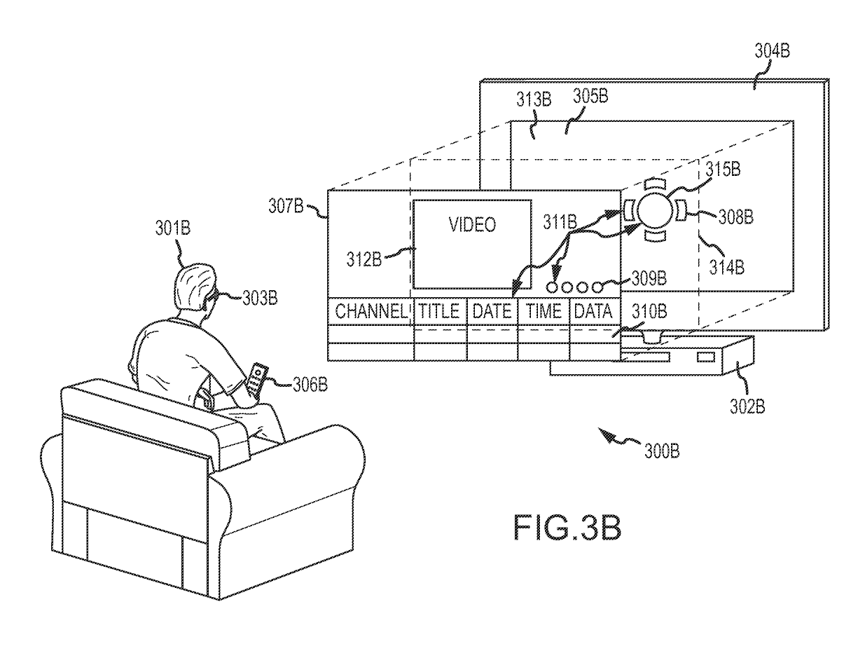

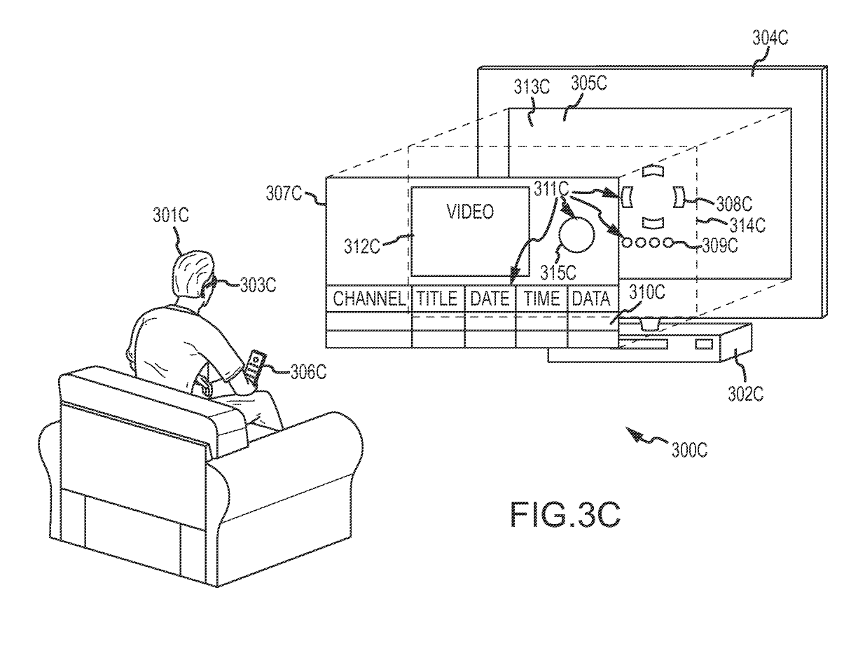

FIGS. 3A-3C are diagrams illustrating a system 300A-300C utilized by a user 301A-301C. The system 300A-300C provides 3D on screen display content derived from 2D on screen display content utilizing the on screen display image buffer of the content receiver 302A-302C. The system 300A-300C may be the system 100 of FIG. 1, and thus the 3D content displayed utilizing the system 300A-300C is due to the on screen display image buffer of the content receiver 102 processing image data in the manner described above in connection with FIGS. 1 and 2. As illustrated in FIG. 3A, the user 301A at the content receiver 302A generally utilizes 3D glasses 303A for viewing 3D content on the content display device 304A. The content display device 304A is generally configured as a 3D display device having a display screen 305A, and the user 301A utilizes the controller 306A to make selections. The 3D glasses 303A may enable the user 301A to perceive images displayed on the display screen 305A of the content display device 304A as a 3D image. That is, 3D images are generally perceived by the user 301A as having depth due to the content on the display screen 305A being provided as two images that are slightly offset from one another, one of which is intended for the right eye and the other is intended for the left eye. The 3D glasses 303A (with polarized lenses or LCD lenses synchronized with the 3D display refresh) enable the user 301A to perceive depth even though the display screen 305A displays images in two dimensions. In FIG. 3A, the user 301A perceives the 3D images as being displayed on the imaginary 3D plane 307A of the display screen 305A. For example, the imaginary 3D plane 307A displays selection buttons 308A, command icons 309A and a program menu 310A, each corresponding to the on screen display content 311A. Video content 312A is also displayed in the imaginary 3D plane 307A. However, because the on screen display image buffer and the video buffers (image and 3D) of the content receiver 302A operate independently of one another, the video content 312A may also be provided as 2D content on the 2D plane 313A of the display screen. Utilizing the controller 306A, the user 301A selects images displayed on the imaginary 3D plane 307A, and the selections, inputs or commands are received by the content receiver 302A for subsequent processing by the processing unit 124.

FIG. 3B illustrates the system 300B in which the display screen 305B of the content display device 304B enables the user 301A to perceive the 3D images as displayed on both the first imaginary 3D plane 307A and a second imaginary 3D plane 314B. The user perceives the images as projecting from the display screen 305B at different planes or elevations due to the degree of offset the first and second images exhibit relative to one another on the 2D plane 313B of the display screen 305B. In FIG. 3B, the selection buttons 308B are perceived as being arranged in the second imaginary 3D plane 314B due to the differing offset relative to the command icons 309B and the program menu 310B, which are perceived as being displayed on the first imaginary 3D plane 307B. More than two planes may be provided, and in some implementations the planes may be perceptible as being separate such as in FIG. 3B. In other implementations, some of the planes may not be easily perceptible. For example, in the case of a “select button,” the “select” image may be slightly elevated from the button image, but each may be substantially perceived by the user as being located on the first or the second imaginary 3D plane 307B or 314B.

FIG. 3C illustrates the system 300C in which the content receiver 302C adjusts the depth of the image of the on screen display content 311C. The content receiver 302C may dynamically adjust offset of the first and second images, and thus the perceived depth of the on screen display content 311C, for example, based on frequency of use of certain features (such as the icons or commands) of the on screen display. In another example, the content receiver 302C may receive input from the user 301C by way of controller 306C transmitting control signals to the processing unit 124 of the content receiver 302C. Thus, in FIG. 3C, the enter button 315C may be perceived as being in the imaginary 3D plane 307C, which is in contrast to FIG. 3B where the enter button 315B is perceived as being in the second imaginary 3D plane 314B. In addition, the command icons 309C may be perceived as being located in the second imaginary 3D plane 314C in FIG. 3C, while in FIG. 3B, the command icons 309B may be perceived as being in the first imaginary plane 307B. While the images forming the on screen display may be moved from one imaginary 3D plane 307C, 314C to another, the on screen display images may also be moved from side-to-side, top-to-bottom, or any combination thereof.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The above disclosure may be provided as a computer program product, or software, that may include a data storage units provided as non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for providing on screen display content in a three-dimensional format utilizing a content receiver, the method comprising:
receiving image data at the content receiver, the image data corresponding to one of a plurality of images to be transmitted to a content display device for display as an on screen display, the on screen display being separate from video content displayed by the content display device;
providing the image data to an on screen display image buffer of the content receiver;
utilizing the on screen display image buffer to:
separate the image data into data for a first image and data for a second image; and
format the data for the first image and the data for the second image for an offset display on the content display device; and
utilizing the content receiver to transmit the formatted data for the first and the second image to the content display device, wherein the formatted first and second images displayed on the content display device are configured to be perceived as a three-dimensional image forming a portion of the on screen display.

2. The method of claim 1, wherein the on screen display image buffer retrieves data corresponding to a height, width and a starting position for the image and separates the image into the first and the second image based on the retrieved data.

3. The method of claim 1, wherein:
the image is comprised of a plurality of successive individual pixels;
the on screen display image buffer assigns numbers in corresponding succession to each of the successive individual pixels; and
the on screen display image buffer separates the image into the first and the second image based on the number assigned to each successive individual pixel.

4. The method of claim 1, wherein about half of the image data is associated with the first image and an other of about half of the image data is associated with the second image.

5. The method of claim 1, wherein a plurality of images are separated by the on screen image buffer, and wherein each of the plurality of images is separated into the first and the second image on a per image basis.

6. The method of claim 5, wherein the plurality of images are formatted with a differing offset such that each of the plurality of images is perceived as a three-dimensional image having a depth that is different from a depth of the other of the plurality of images.

7. The method of claim 6, wherein the plurality of images are formatted with the differing offset based on a relevance assigned to each of the images utilizing the content receiver.

8. The method of claim 6, wherein the plurality of images are formatted with the differing offset based on user preferences entered into the content receiver.

9. The method of claim 1, wherein the on screen display image buffer formats the image with an offset corresponding to a degree of depth which the three-dimensional content is to be perceived.

10. A system for providing on screen display content in a three-dimensional format utilizing a content receiver, comprising:
an on screen display image buffer;
a processing unit controlling the on screen display image buffer, the processing unit operative to retrieve image data corresponding to one of a plurality of images to be transmitted to a content display device for display as an on screen display that is separate from video content displayed by the content display device; and
a memory unit comprising memory accessible by the on screen display image buffer;
wherein the on screen display image buffer:
separates the image data into data for a first image and data for a second image; and
formats the data for the first image and the data for the second image for an offset display on the content display device; and
a communications unit for transmitting the formatted data for the first and the second image to the content display device;
wherein the formatted first and second images transmitted to the content display device form a three-dimensional perceptual image as a portion of the on screen display.

11. The system of claim 10, wherein processing unit executes instructions such that the on screen display image buffer retrieves data corresponding to a height, width and a starting position for the image and separates the image into the first and the second image based on the retrieved data.

12. The system of claim 10, wherein:
the processing unit receives the image as a plurality of successive individual pixels;
the on screen display image buffer assigns numbers in corresponding succession to each of the successive individual pixels; and
the on screen display image buffer separates the image into the first and the second image based on the number assigned to each pixel.

13. The system of claim 10, wherein the on screen display image buffer separates about half of the image data into the first image and separates the other of about half of the image data into the second image.

14. The system of claim 11, wherein the on screen display image buffer separates a plurality of images, and wherein each of the plurality of images is separated into the first and the second image on a per image basis.

15. The system of claim 14, the wherein the on screen display image buffer formats the plurality of images utilizing a differing offset such that each of the plurality of images is perceived as a three-dimensional image having a depth that is different from a depth of the other of the plurality of images.

16. The system of claim 15, wherein the on screen display image buffer formats the plurality of images with the differing offset based on a relevance assigned to each of the images utilizing the content receiver.

17. The system of claim 15, wherein the on screen display image buffer formats the plurality of images with the differing offset based on user preferences entered into the content receiver.

18. The system of claim 10, wherein the on screen display image buffer formats the image with an offset corresponding to a degree of depth which the three-dimensional content is to be perceived.

19. A computer program product comprising:
a first set of instructions, stored in at least one non-transitory machine readable medium, executable by at least one processing unit to separate image data into data for a first image and data for a second image, wherein the image data corresponds to data for one of a plurality of images to be transmitted to a content display device for display as an on screen display that is separate from video content displayed by the content display device; and
a second set of instructions, stored in the at least one non-transitory machine readable medium, executable by the at least one processing unit to format the data for the first image and the data for the second image for an offset display on the content display device, wherein the image data is formatted such that the formatted first and second images displayed on the content display device are to be perceived as a three-dimensional image forming a portion of the on screen display.

20. The computer program product of claim 19, further comprising a third set of instructions, stored in the at least one non-transitory machine readable medium, executable by the at least one processing unit to format two or more of the plurality of images with a differing offset such that each of the two or more images is perceived as a three-dimensional image having different relative depths.
